(19) United States
(12) Patent Application Publication
(10) Pub. No.: US 2017/0305004 A1
(43) Pub. Date: Oct. 26, 2017

(54) Fastener Removal Tool for Quickly, Safely, and Easily Removing Push Pin Panel Fasteners

(71) Applicant: Robert Paul Marquis, Exeter, NH (US)

(72) Inventor: Robert Paul Marquis, Exeter, NH (US)

(21) Appl. No.: 15/644,607

(22) Filed: Jul. 7, 2017

Related U.S. Application Data
(63) Continuation-in-part of application No. 14/644,271, filed on Mar. 11, 2015.

(51) Int. Cl. B25B 27/02

(52) U.S. Cl. CPC B25B 27/02

(57) ABSTRACT

A panel fastener tool is disclosed that includes a first arm pivotally connected to a second arm. Each of the first arm and second arm include a camming portion, a camming surface, a terminal projection projecting substantially inwardly, and an indent between the camming portion and the terminal projection. Upon pivoting the first arm and the second arm towards each other, the camming surfaces each engage a top portion of an inner member of a fastener inserted into a hole in a workpiece. The camming surfaces lift the inner member out of an insertable member of the fastener, and the terminal projections capture a head portion of the insertable member within the indents. When an upward force is applied, the terminal projections lift the insertable member from the hole.

### CROSS-REFERENCE TO RELATED APPLICATIONS

The present application is a continuation-in-part of U.S. Ser. No. 14/644,271, filed Mar. 11, 2015, titled “PANEL FASTENER TOOL FOR QUICKLY, SAFELY, AND EASILY REMOVING AND INSERTING PANEL FASTENERS” (Attorney Docket No. MARQUIS-001), which is hereby incorporated by reference in its entirety.

### FIELD OF THE INVENTION

This invention generally relates to panel fasteners, and more particularly to tools and methods for removing push pin panel fasteners.

### BACKGROUND

Push pin style panel fasteners are used in a wide array of applications ranging from automotive trim attachment to shelving, furniture assembly, etc. One particularly prevalent fastener style has a two-part construction, whereby a substantially cylindrical outer insertable member having a flared head portion is adapted to be secured to a workpiece. The outer insertable member has a hollow portion that typically runs longitudinally therethrough. This fastener also includes an inner member that fits into the hollow portion of the outer insertable member. The outer insertable member is deformable, such that its projections are flared out once the fastener is inserted into a hole in a panel, effectively locking the panel fastener in place. An example of such a prior art panel fastener is illustrated in FIG. 1. Another example of such a prior art panel fastener often used in the automotive industry is illustrated in FIG. 2. Both panel fasteners are discussed in further detail below.

Various tools and techniques are sometimes used to remove of such panel fasteners. For example, a flat blade can be wedged under the fastener head, and the fastener can then be pried out of the panel into which it is inserted. This necessitates that the tool be pivoted to lift the fastener away from the panel. Unfortunately, this requires a long travel of a handle to which the blade is attached such that use in confined spaces is limited or even impossible.

Often, the space in which the fastener is located may have limited headroom for extraction. For example, a wall or other obstruction may be located above the fastener head making it difficult to access. Existing tools and techniques require a substantial amount of space above the fastener head to manipulate the tool during fastener extraction thereby rendering them unfit in such situations.

Also, such tools and techniques often scratch or otherwise damage the surface of the panel, since the blade itself must engage the surface during rotation of the tool as it pries out the fastener. Similar issues arise with flat-head screwdrivers, or generic pry tools, which are generally poorly suited for removing these fasteners. Besides damage to surrounding panels, these tools can also damage the panel fasteners themselves, effectively rendering them unavailable for subsequent use.

### SUMMARY

The panel fastener tool of the invention quickly and easily facilitates removal of push pin panel fasteners. Further, the fastener tool can remove such push pin panel fasteners safely, i.e., without damaging the adjacent panel surface or the two-piece panel fastener itself, meaning that the fastener can be reused. Certain embodiments have a low-profile to allow the tool to be used in situations in which the headroom above the fasteners limited. Additionally, certain embodiments of the tool are particularly well suited for removing fasteners having an outer insertable member with a radial groove in its head portion.

One general aspect of the invention is directed to a tool configured to remove a fastener from a workpiece. The fastener includes an outer insertable member configured for insertion into a hole in the workpiece and an inner member within the outer insertable member. The outer insertable member expands in response to inward axial movement of the inner member to retain the fastener within the hole and contracts in response to an outward axial movement of the inner member from the outer insertable member to loosen the fastener from the hole. The tool includes a first arm pivotally connected to a second arm. Each of the first and second arms include a main arm extending from a pivot connection along a longitudinal axis. The main arm includes an outer surface having a gripping portion configured for direct contact with a digit of a user. The first and second arms further include a transverse portion extending from an end of the main arm along a first transverse axis that is generally perpendicular to the longitudinal axis, a terminal projection extending generally perpendicular and inwardly from the transverse portion, the terminal projection having a primary camming surface, and a pivot arm extending along a second transverse axis that is generally perpendicular to the longitudinal axis. The primary camming surfaces engage the inner member of the fastener upon application of an inward force at the gripping portions by digits of the user. The primary camming surfaces lift the inner member from the outer insertable member to enable extraction of the fastener from the workpiece when a rotational force is applied about the pivot arm with the pivot arm rested against a surface of the workpiece.

In one embodiment each of the first and second arms further include knurling along the outer surface at the gripping portions.

In another embodiment, the terminal projection of each of the first and second arms has a first width proximate the respective transverse portion and tapers to a second width distal the respective transverse portion, wherein the first width is greater than the second width, and wherein the second width is less than a width of a radial groove in an upper portion of the outer insertable member.

In another embodiment, the primary camming surface of each of the first and second arms is curved.

In another embodiment, each of the first and second arms includes a further camming surface opposite the primary camming surface, and the further camming surface is curved.

In another embodiment, each of the first and second arms includes a further camming surface opposite the primary camming surface, and the further camming surface is generally flat.

In another embodiment, the primary camming surface of each of the first and second arms is shaped as a generally linear ramp.

In another embodiment, each of the first and second arms includes a further camming surface opposite the primary camming surface, and the further camming surface is generally flat.

In another embodiment, each of the first and second arms includes an inner wall, wherein the transverse portion and pivot arm extend from the inner wall.

In another embodiment, the tool includes a biasing member connected to the first arm and the second arm, the biasing member biasing the first arm and second arm away from each other.

Another general aspect of the invention is directed to a tool that is configured to remove a fastener from a workpiece. The fastener includes an outer insertable member configured for insertion into a hole in the workpiece and an inner member within the outer insertable member. The outer insertable member expands in response to inward axial movement of the inner member to retain the fastener within the hole and contracts in response to an outward axial movement of the inner member from the outer insertable member. The tool includes a first arm pivotally connected to a second arm. Each of the first and second arms includes a main arm extending from a pivot connection along a longitudinal axis. The main arm includes an outer surface having a gripping portion configured for direct contact with a digit of a user. Each of the first and second arms also includes a transverse portion extending from an end of the main arm along a transverse axis that is generally perpendicular to the longitudinal axis, and a terminal projection extending generally perpendicular to and inwardly from the transverse portion, the terminal projection having a primary camming surface. The primary camming surfaces engage the inner member of the fastener upon application of an inward force at the gripping portions by digits of the user, and the primary camming surfaces lift the inner member from the outer insertable member to enable extraction of the fastener from the workpiece when a lifting force is applied in a direction of the transverse axis.

In one embodiment, each of the first and second arms further include knurling along the outer surface at the gripping portions.

In another embodiment, the terminal projection of each of the first and second arms has a first width proximate the transverse portion and tapers to a second width distal the transverse portion, wherein the first width is greater than the second width, and wherein the second width is less than a width of a radial groove in an upper portion of the outer insertable member.

In another embodiment, the tool further includes a pivot arm extending along a further transverse axis that is generally perpendicular to the longitudinal axis, wherein application of a rotational force about the pivot arm with the pivot arm rested against a surface of the workpiece results in the lifting force along the transverse axis.

In another embodiment, each of the first and second arms includes a further camming surface opposite the primary camming surface, and the further camming surface is concave shaped.

In another embodiment, each of the first and second arms includes a further camming surface opposite the primary camming surface, and the further camming surface is generally flat.

In another embodiment, the primary camming surface of each of the first and second arms is shaped as a generally linear ramp.

In another embodiment, each of the first and second arms includes a further camming surface opposite the primary camming surface, and the further camming surface is generally flat.

Another general aspect of the invention is directed to a tool configured to remove a fastener from a workpiece. The fastener includes an outer insertable member configured for insertion into a hole in the workpiece and an inner member within the outer insertable member. The outer insertable member expands in response to inward axial movement of the inner member to retain the fastener within the hole and contracts in response to an outward axial movement of the inner member from the outer insertable member. The tool includes a first arm pivotally connected to a second arm. Each of the first and second arms includes a main arm extending from a pivot connection, the main arm including an outer surface having a gripping portion configured for direct contact with a digit of a user, a tapered section extending from a lower portion of the main arm, and a terminal projection extending inward from the tapered section. Each terminal projection has a primary camming surface. The primary camming surfaces engage the inner member of the fastener upon application of an inward force at the gripping portions by digits of the user. The primary camming surfaces lift the inner member from the outer insertable member to enable extraction of the fastener from the workpiece when a lifting force is applied to cause outward axial movement of the inner member from the outer insertable member.

In one embodiment, the outer insertable member includes a radial groove extending from an outer periphery thereof to an outer periphery of the inner member, and the terminal projection of each of the first and second arms has a width that is less than a width of the radial groove.

### BRIEF DESCRIPTION OF THE DRAWINGS

For a fuller understanding of the invention, reference is made to the following detailed description, taken along with the accompanying drawings illustrating various embodiments of the present invention, in which:

FIG. 1 is a cross-sectional view of one example of a push pin panel fastener that can be used to secure hardware to a workpiece.

FIG. 2 is a perspective view of a further example of a push pin panel fastener that can be used to secure hardware to a work piece, where the panel fastener is in an unsecured state.

FIG. 3 is a perspective view of the panel fastener of FIG. 2, where the panel fastener is in a secured state.

FIG. 4 is an exploded view of a first embodiment of a tool for removing a push pin fastener.

FIG. 5 is a perspective view of the first embodiment of the tool in an initial position in which it is ready to remove the fastener.

FIG. 6 is an end view of the first embodiment of the tool in the initial position in which it is ready to remove the fastener.

FIG. 7 is a perspective view of the first embodiment of the tool in an intermediate removal position in which the arms have been rotated toward one another about the pivot connection.

FIG. 8 is an end view of the first embodiment of the tool in the intermediate removal position.

FIG. 9 is a side elevational view of the first embodiment of the tool in the intermediate removal position.

FIG. 10 is a side elevational view of the first embodiment of the tool in a further intermediate removal position in which a rotational force has been applied about the pivot arms with their curved ends resting as a fulcrum against the surface of a workpiece.

FIG. 11 is a perspective view of a second embodiment of a tool for removing a push pin fastener.

FIG. 12 is a perspective view of a third embodiment of a tool for removing a push pin fastener, where the tool is in an initial position in which it is ready to remove a fastener.

FIG. 13 is a side elevational view of the third embodiment of the tool in the intermediate removal position.

FIG. 14 is a side elevational view of the third embodiment of the tool in a position in which a lifting force has been applied to remove the fastener from the workpiece.

FIG. 15 is a perspective view of a fourth embodiment of a tool for removing a push pin fastener.

FIG. 16 is a perspective view of a fifth embodiment of a tool for removing a push pin fastener, where the tool is in an initial position in which it is ready to remove a fastener.

FIG. 17 is a side view of the fifth embodiment of the tool, where the tool is in the initial position.

FIG. 18 is a side view of the fifth embodiment of the tool, where the tool is in an intermediate removal position.

FIG. 19 is a perspective view of a sixth embodiment of a tool for removing a push pin fastener.

FIGS. 20A-20F are side elevational views of various shapes of the end portion of each terminal projection of a tool for removing a push pin fastener, such as the embodiments shown in FIGS. 5, 11, 15, 16, and 19, for example, so as to accommodate the various shapes of the head portion and/or the shaft of a variety of push pin fasteners.

### DETAILED DESCRIPTION

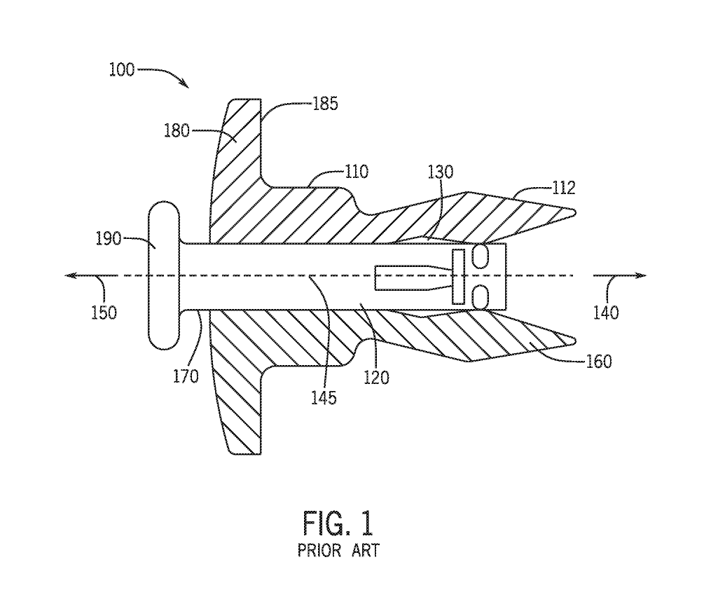

FIG. 1 is a cross-section of one example push pin panel fastener 100 that can be used to secure hardware to a workpiece (e.g., a panel, such as a surface on a table, a bench, a vehicle, machinery, etc.). As illustrated, the fastener 100 includes a substantially outer insertable member 110 configured for insertion into a hole in a workpiece. The fastener 100 also includes an inner member 120 axially disposed within a hollow portion 130 of the outer insertable member 110. In one example, the inner member 120 is aligned within a central axis 145 of the fastener. The outer insertable member 110 expands in response to inward axial movement of the inner member 120 along central axis 145 in the direction shown by arrow 140 to retain the fastener within the hole of the workpiece. The outer insertable member 110 contracts in response to an outward axial movement along central axis 145 of the inner member 120 from the outer insertable member 110 in the direction of arrow 150 to loosen the fastener 100 from the hole.

In this regard, the outer insertable member 110 can be deformable, such that projections 160 thereon can be flared out after the fastener 100 is inserted into a hole in the workpiece panel, effectively locking the fastener 100 in place. More particularly, the projections 160 can be biased in a contracted configuration when the inner member 120 is not fully inserted into the hollow portion 130. Since the projections 160 are contracted, the fastener 100 may be inserted into the hole of the workpiece. By pushing the inner member 120 into the hollow portion 130 of the outer insertable member 110 in the direction of arrow 140, a shaft 170 of the inner member 120 forces the projections 160 outward in a flared-out configuration. This expands the bottom portion of the fastener 100 that extends through the hole, thereby making it larger than the hole and securing the fastener 100 within the hole. Similarly, when the inner member 120 is pulled in the direction of arrow 150, the shaft 170 reduces its forces on the projections 160 so that they begin to return to their contracted configuration thereby allowing the fastener 100 to be removed from the workpiece.

In this example, the outer insertable member 110 has a head portion 180. The head portion 180 can include a bottom surface 185 that can abut the workpiece when installed. As such, the head portion 180 lays generally flat against the workpiece.

The inner member 120 also includes a head portion 190. When the fastener is secured with the workpiece, the bottom of the head portion 190 abuts the top surface of the head portion 180.

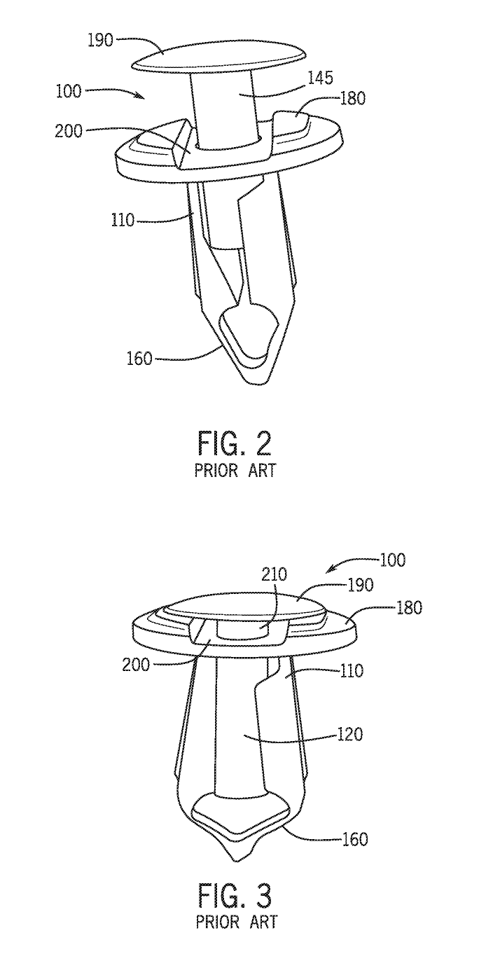

FIG. 2 and FIG. 3 show another example of a push pin panel fastener, where FIG. 2 shows the fastener in its unsecured state, and FIG. 3 shows the fastener in its secured state. The principal differences between the fastener of FIG. 1 and the fastener of FIGS. 2 and 3 lie in the configuration of the upper portion of the fastener. In the embodiment of FIGS. 2 and 3, the head portion 180 of the outer insertable member 110 includes a radial groove 200 disposed through its upper surface. When the inner member 120 is driven into the hollow portion of the outer insertable member 110 to secure the fastener to the workpiece, a gap 210 remains between the upper surface of the radial groove 200 and a lower surface of the head portion 180.

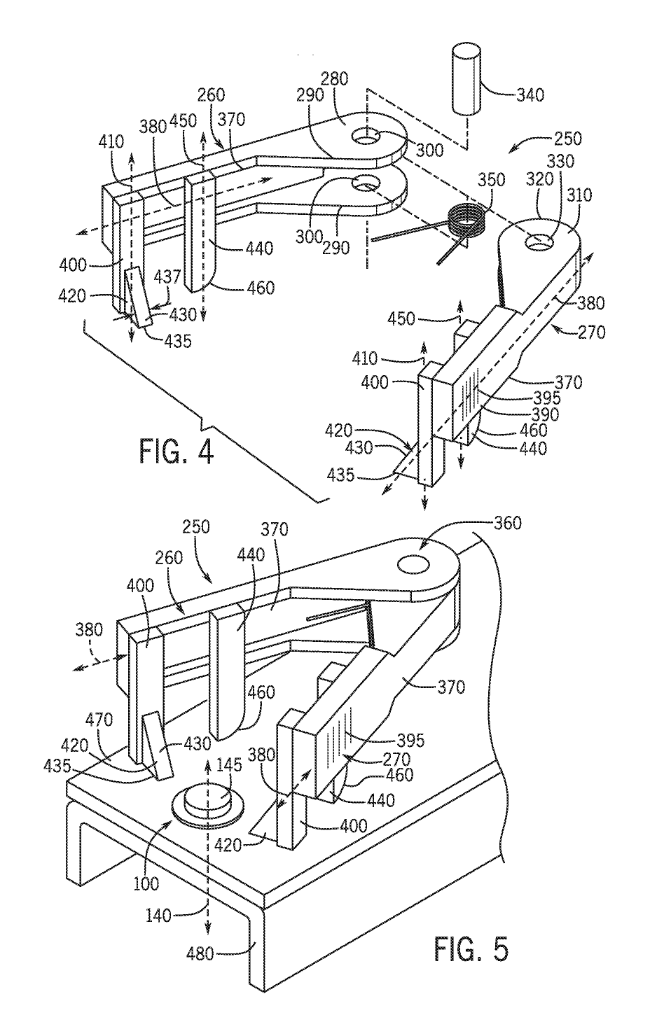

FIG. 4 is an exploded view of a tool 250 for removing fasteners, such as the panel fasteners 100 shown in FIGS. 1-3, from a workpiece. The tool 250 facilitates easy removal of such fasteners, thereby saving a user of the tool 250 a substantial amount of time during the removal operation. Further, the tool 250 can remove fasteners in a manner that leaves the fasteners intact post-removal, allowing the fasteners to be reused. Still further, the tool 250 allows removal of such fasteners without damaging the surface of the workpiece.

The tool 250 of this embodiment includes a first arm 260 that is pivotally connected to a second arm 270. Arm 260 includes a connection portion 280 having a pair of spaced apart walls 290 each having an annular opening 300 therethrough. Similarly, arm 270 includes a connection portion 310 having a pair of spaced apart walls 320 each having an annular opening 330. The spaced apart walls 290 and spaced apart walls 320 overlap one another when the tool 250 is assembled.

With the connection portions 280, 310 overlapping, the annular openings 300 and 330 are aligned to receive a pivot pin 340. The pivot pin 340 extends through an opening of a torsion spring 350 to form a pivot connection 360 (FIG. 5). The ends of the torsion spring 350 engage interior walls of the connection portions 280 and 310 so that the arms 260 and 270 are biased outward from one another. The extent to which the arms pivot outward in response to this bias may be limited in any of a variety of manners including, for example, one or more stop members (not shown) on the arms 260, 270, connection portions 280, 310, and/or the torsion spring 350.

Each arm 260, 270 includes a main arm 370 extending from the pivot connection 360 along a longitudinal axis 380. The main arm 370 includes an outer surface having a gripping portion 390 configured for direct contact with a digit of a user. The gripping portion 390 may include knurling 395 to enhance friction between the respective arm and the digit of the user. Each arm 260, 270 also includes a transverse portion 400 extending from an end of the main arm 370 along a first transverse axis 410. In the illustrated embodiment, the first transverse axis 410 is generally perpendicular to the longitudinal axis 380. A terminal projection 420 extends generally perpendicular and inwardly from the transverse portion 400 and has a primary camming surface 430 that, for example, may be in the form of a generally linear ramp. The terminal projection 420 may also include a further camming surface 435 opposite the primary camming surface 430. The further camming surface 435 shown in this example is in the form of a flat surface that, for example, abuts an upper surface of the head portion 180 during extraction of the fastener 100. One or both of the primary camming surface 430 and further camming surface 435 may additionally, or in the alternative, be curved. Also, the tool 250 may be particularly adapted for use with the fastener 100 shown in FIGS. 2 and 3 by dimensioning the width 437 of each terminal projection 420 so that it is less than the width of the radial groove 200. This allows the terminal projections 420 to enter gap 210 during the extraction process.

A pivot arm 440 extends along a second transverse axis 450. Here, the second transverse axis 450 is generally perpendicular to the longitudinal axis 380. The distance between the connection portion 280 and the pivot arm 440 of this example is greater than the distance between the pivot arm 440 and the transverse portion 400. However, this distance may be varied depending on the mechanical advantage desired to remove the fastener 100. This is also true of the distance between the pivot arm 440, connection portion 310, and transverse portion 400 of the second arm 270.

The pivot arm 440 may terminate at a curved end 460. In various examples, the curved ends 460 may extend a slight distance beyond the further camming surface 435 at the end of the terminal projection 420. This difference in length may correspond to the height of the head portion 190 of the fastener 100 so that the primary camming surface 430 may grip the head portion 190 while the curved end 460 engages the surface of the workpiece during the removal operation. Alternatively, the further camming surface 435 may extend beyond the curved end 460 so that the primary camming surface 430 grips the head portion 190 while the curved end 460 still lies above the surface of the workpiece. This allows the user to operate the tool 250 to grip the head portion 190 without contact between the curved end 460 and the surface of the workpiece as the arms 260, 270 are moved toward one another during the removal operation. In a still further embodiment, there is no difference in these lengths.

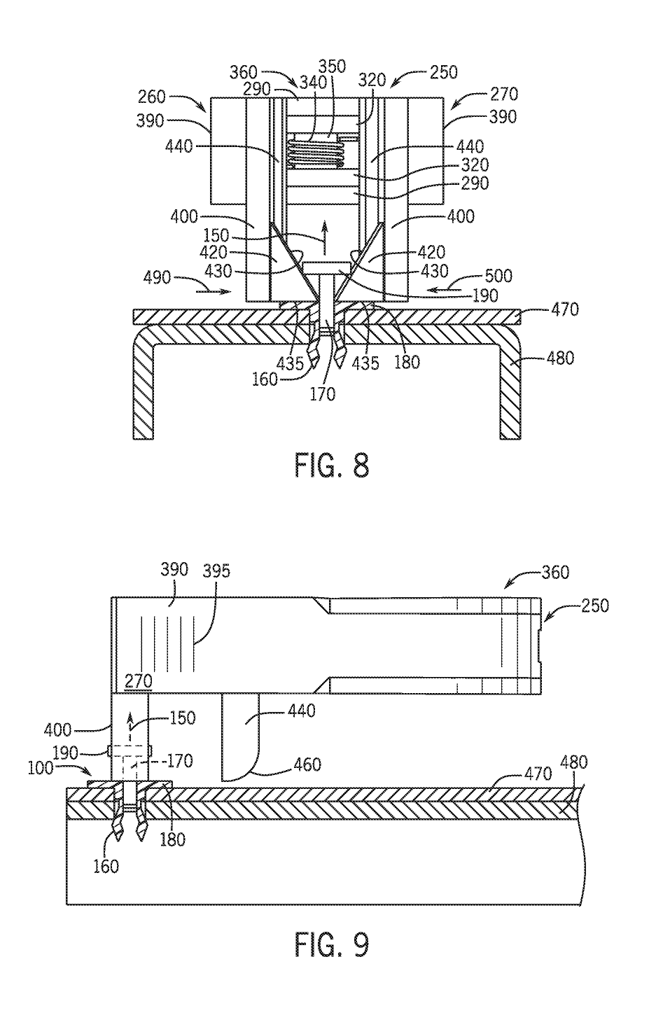

The low-profile access to and removal of the fastener 100 by the tool 250 will be apparent from FIGS. 5-10 and corresponding description of its use as set forth below.

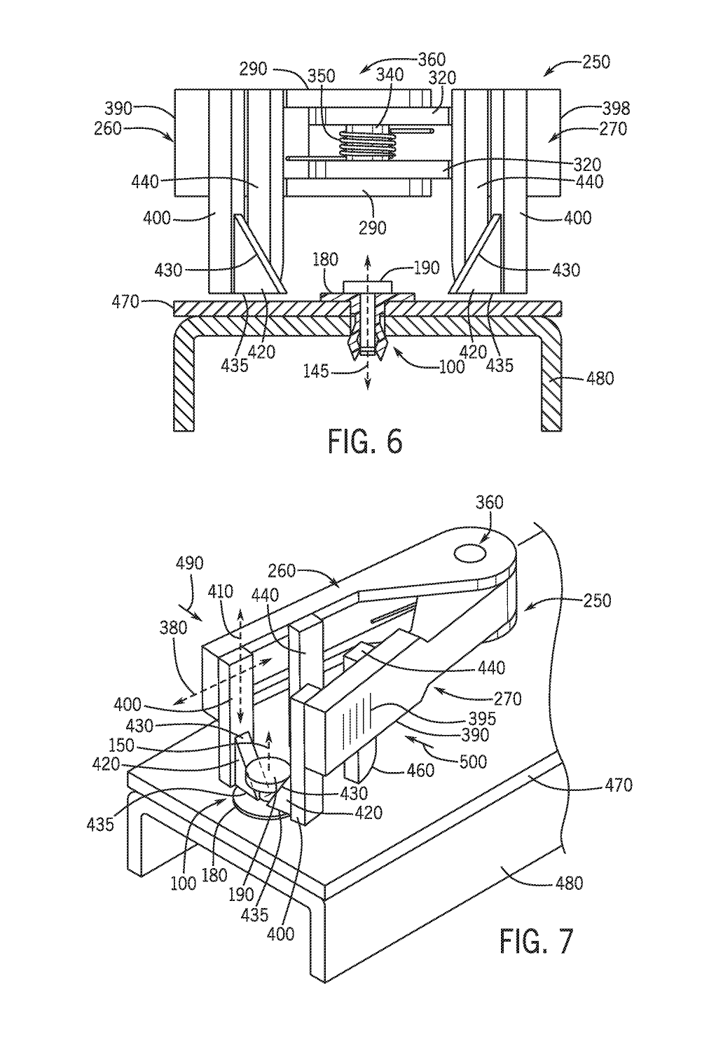

FIG. 5 and FIG. 6 show the tool 250 in an initial position in which it is ready to remove the fastener 100. Here, the fastener 100 is used to bind a first workpiece 470 with a second workpiece 480. In this position, the first arm 260 and second arm 270 are biased apart from one another about the pivot connection 360 and have their transverse axes 410 disposed approximately parallel to the central axis 145 of the fastener 100. The longitudinal axes 380 are also shown to be generally parallel to the outer surface of the first workpiece 470. This configuration has a relatively low profile which allows the tool to be inserted and used in situations in which the head room above the head portion 190 of the fastener 100 is limited.

FIGS. 7-9 show the tool 250 in an intermediate removal position in which the arms 260, 270 have been rotated toward one another about the pivot connection 360. The arms 260, 270 are rotated to this position through application of forces in directions 490, 500 by the digits of the user at the gripping portions 390. As the arms 260, 270 are rotated toward one another, the further camming surfaces 435 engage the upper surface of the head portion 180 of the outer insertable member 110 and the lower surface of the head 190 of the inner member 120. This generates an extraction force along central axis 145 in the direction of arrow 150 to separate the upper surface of head portion 180 from the lower surface of head portion 190 to at least partially pull the inner member 120 from the hollow portion 130 of the outer insertable member 110. With the inner member 120 at least partially removed from the hollow portion 130, the projections 160 are allowed to contract.

As shown in FIG. 9, the transverse portions 400 extend beyond the curved ends 460 of the pivot arms 440 so that the inner member 120 may be partially extracted without substantial contact between the curved ends 460 and the surface of the first workpiece 470 as the arms 260, 270 are moved toward one another.

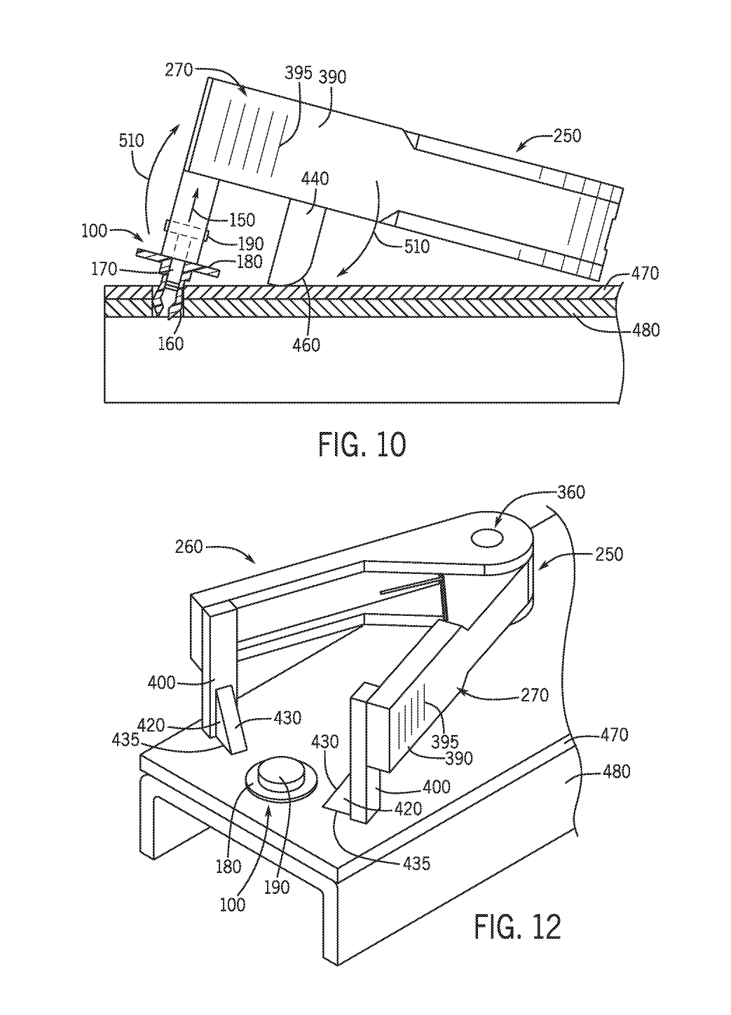

FIG. 10 shows the tool 250 at a further intermediate removal position. Here, the user has applied a rotational force 510 about the pivot arms 440 with the curved ends 460 resting against the surface of the first workpiece 470 as a fulcrum. The rotational force results in a corresponding extraction force in the direction of arrow 150. With the curved ends 460 against the surface of the first workpiece 470, the primary camming surfaces 430 lifts the inner member 120 from the hollow portion 130 of the outer insertable member 110 to pull the fastener from the workpieces 470, 480. Continued application of the rotational force allows further contraction of the projections 160 and so that the fastener 100 may be pried and completely extracted from the workpieces 470, 480.

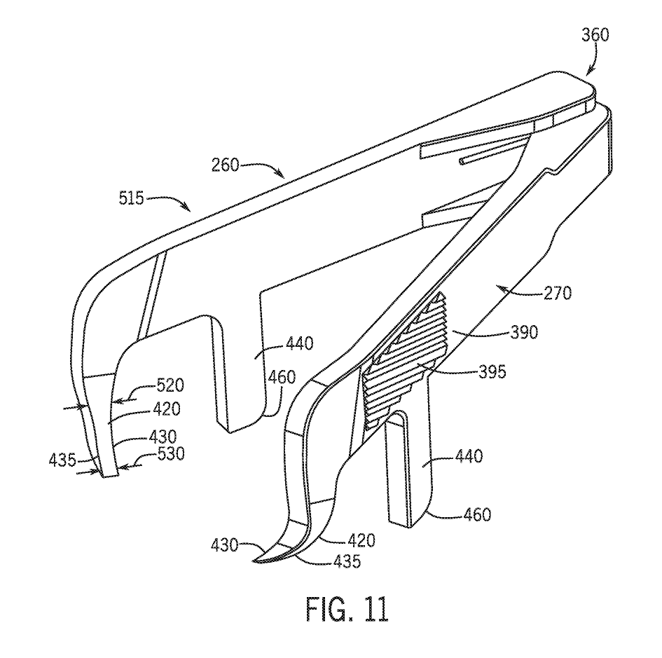

FIG. 11 illustrates another embodiment of a tool 515, where parts of tool 515 that generally correspond to the parts of tool 250 are identified with the same reference numerals. The tool shown in FIG. 11 is particularly suitable for use with panel fasteners of the type shown in FIGS. 2 and 3. To this end, the terminal projections 420 of each of the first and second arms 260, 270 of tool have a first width 520 proximate the respective transverse portion 400 that tapers to a second width 530 distal the respective transverse portion 400. The first width 520 is greater than the second width 530, and the second width 530 is less than a width of the radial groove 200 (FIGS. 2 and 3) to allow the terminal projections 420 to enter the gap 210 during the fastener extraction process.

In the embodiment shown in FIG. 11, the shapes of some of the elements differ from those of tool 250. For example, the primary camming surfaces 430 and further camming surfaces 435 of the tool 515 differ from those shown in the embodiment of the tool 250. More particularly, the primary camming surfaces 430 and further camming surfaces 435 are curved. The radius of curvature of each primary camming surface 435 may be greater than the radius of curvature of each of the further camming surfaces 435. The difference in radial curvatures generates a lifting force in the direction of arrow 150 between the head portion 180 and head portion 190 as the arms 260, 270 are pivoted toward one another about the pivot connection 360. Further, the curved ends 460 of the pivot arms 440 extend beyond the further camming surfaces 435. Otherwise, the operation of the tool 515 is generally similar to the operation of the tool 250.

FIGS. 12-14 show another embodiment of a tool 540 for removing a push pin panel fastener, where parts of tool 540 that generally correspond to the parts of tool 250 are identified with the same reference numerals. Unlike the tools shown in FIGS. 4-11, tool 540 does not have a pivot arm and, as such, operates in a slightly different manner.

FIG. 12 shows the tool 540 in an initial position in which it is ready to remove the fastener 100. Here, the fastener 100 is used to bind a first workpiece 470 with a second workpiece 480. In this position, the first arm 260 and second arm 270 are biased apart from one another about the pivot connection 360 and have their transverse axes 410 disposed approximately parallel to the central axis 145 of the fastener 100. Like the tools 215 and 515, tool 540 has a relatively low profile which allows the tool to be inserted and used in situations in which the head room above the head portion 190 of the fastener 100 is limited.

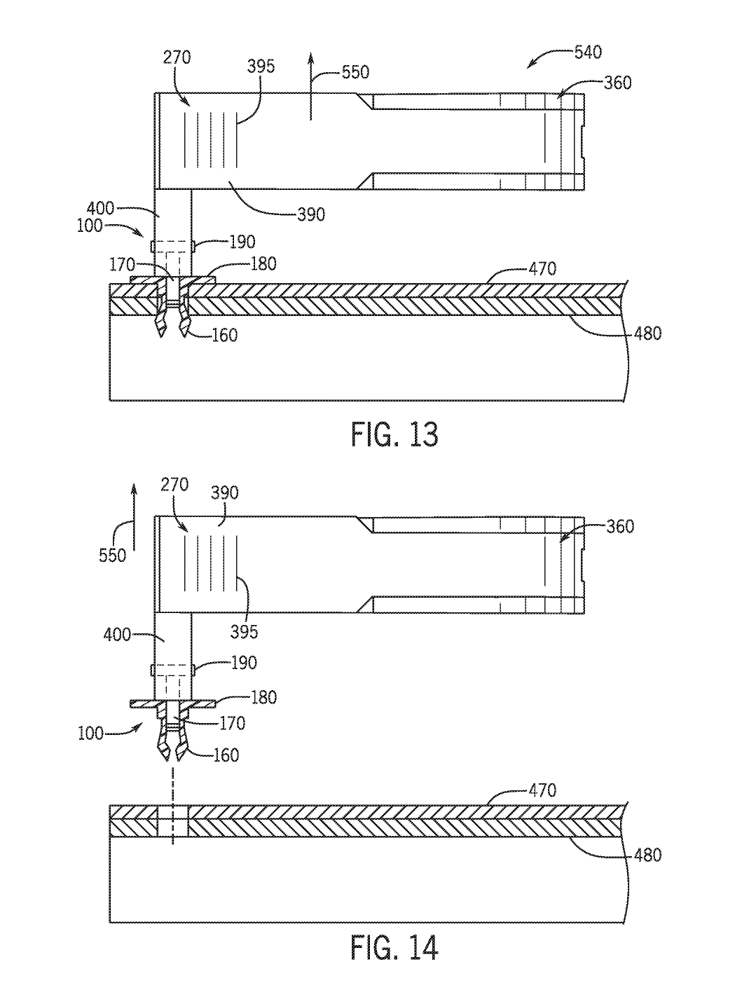

FIG. 13 shows the tool 540 in an intermediate removal position in which the arms 260, 270 have been rotated toward one another about the pivot connection 360. The arms 260, 270 are rotated to this position through application of forces by the digits of the user at the gripping portions 390. As the arms 260, 270 are rotated toward one another, the further camming surfaces 435 engage the upper surface of the head portion 180 of the outer insertable member 110 and lower surface of the head 190 of the inner member 120. This creates an extraction force to at least partially pull the inner member 120 from the hollow portion 130 of the outer insertable member 110. With the inner member 120 at least partially removed from the hollow portion 130, the projections 160 are allowed to contract.

FIG. 14 shows the tool 540 in his state in which the fastener 100 has been completely removed. Here, the user the has applied a lifting force in the direction of arrow 550. The primary camming surfaces 430 lift the inner member 120 from the hollow portion 130 of the outer insertable member 110 to pull the fastener from the workpieces 470, 480.

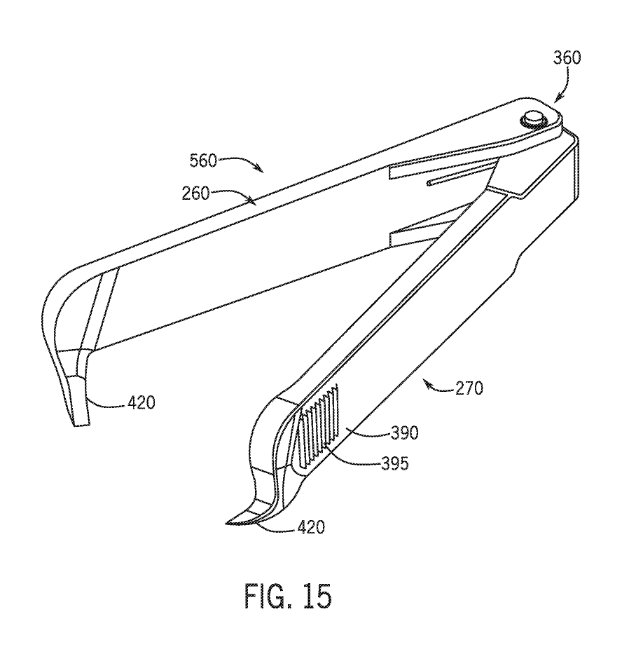

FIG. 15 shows another embodiment of a tool 560 that is similar to tool 540. However, the terminal projections 420 have the same general structure as tool 515. In all other respects, the operation of tool 560 is similar to the operation of tool 515. Again, the configuration of the terminal projections 420 tool 560 render it particularly suitable for use with push pin fasteners such as those shown in FIGS. 2 and 3.

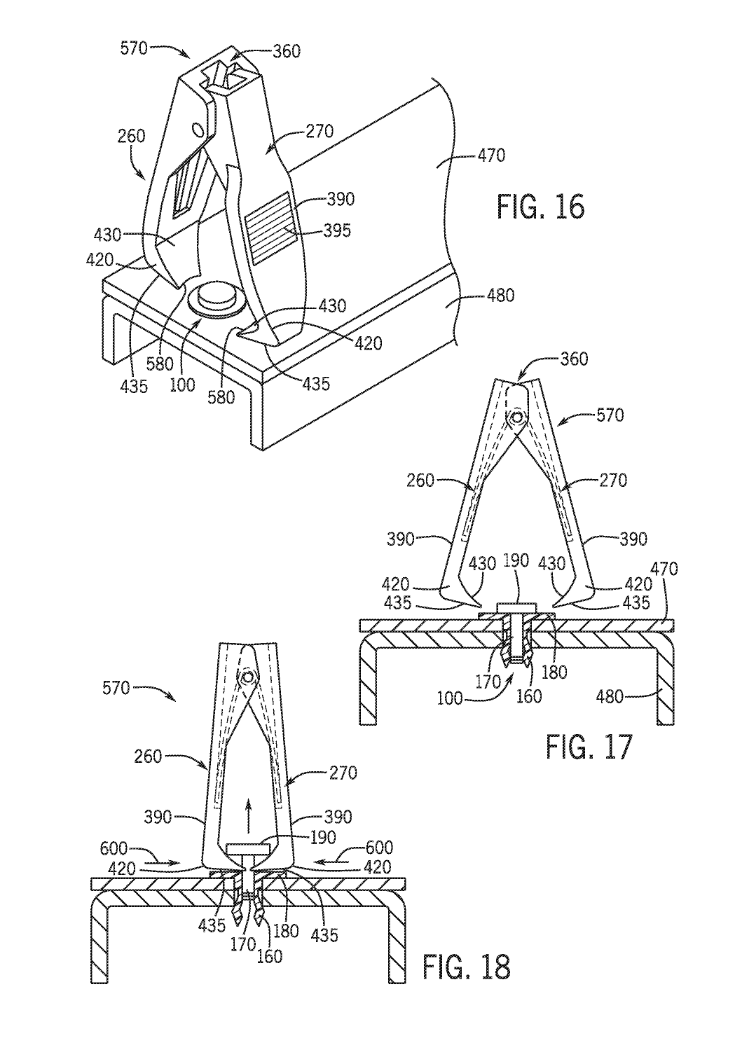

FIGS. 16-18 show another embodiment of a tool 570. The tool 570 is particularly useful in situations in which the head room above the fastener 100 is sufficient to allow vertical extraction of the fastener. In this embodiment, the terminal projections 420 extend inward toward one another directly from the respective main arms 370. The end portion 580 of each terminal projection 420 may be curved. In one example, the curvature of the end portions 580 may generally correspond to the curvature of the head portion 190 and/or shaft 170 of the fastener 100.

FIGS. 16 and 17 show the tool 570 in an initial position in which it is ready to remove the fastener 100. Again, the fastener 100 is shown binding a first workpiece 470 with a second workpiece 480. In this position, the first arm 260 and second arm 270 are biased apart from one another about the pivot connection 360 and disengaged from the fastener 100.

FIG. 18 shows the tool 570 in an intermediate removal position in which the arms 260, 270 have been rotated toward one another about the pivot connection 360. The arms 260, 270 are rotated to this position through application of forces in the directions of arrows 600 by the digits of the user at the gripping portions 390. As the arms 260, 270 are rotated toward one another, the further camming surfaces 435 engage the upper surface of the head portion 180 of the outer insertable member 110 and the primary camming surfaces 420 engage the lower surface of the head 190 of the inner member 120. This generate an extraction force in the direction of arrow 150 to at least partially pull the inner member 120 from the hollow portion 130 of the outer insertable member 110. With the inner member 120 at least partially removed from the hollow portion 130, the projections 160 are allowed to contract. Further application of a lifting force in the direction of arrow 150 allows complete removal of the fastener 100.

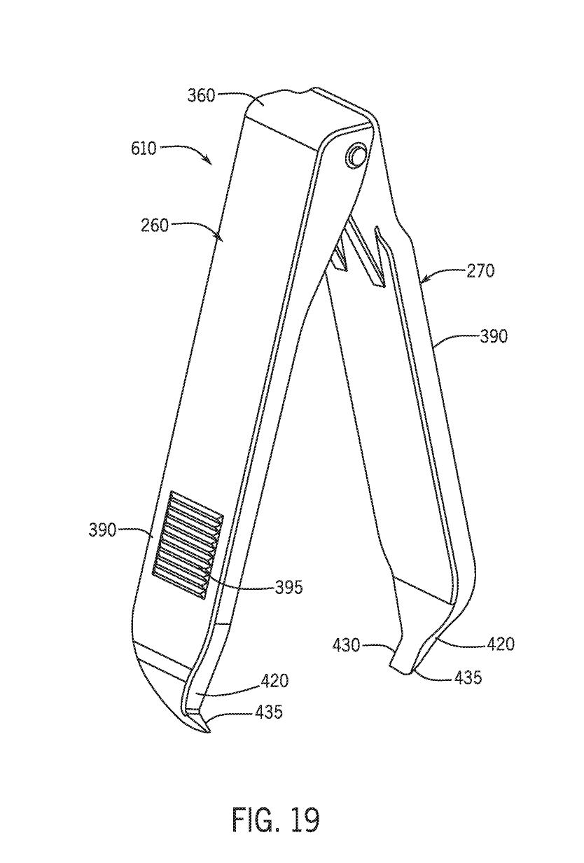

FIG. 19 shows another embodiment of a tool 610 that is similar to tool 570. However, the terminal projections 420 have the same general structure as tool 515. In all other respects, the operation of tool 560 is generally similar to the operation of tool 570. Again, the configuration of the terminal projections 420 of tool 560 render it particularly well suited for use with push pin fasteners such as those shown in FIGS. 2 and 3.

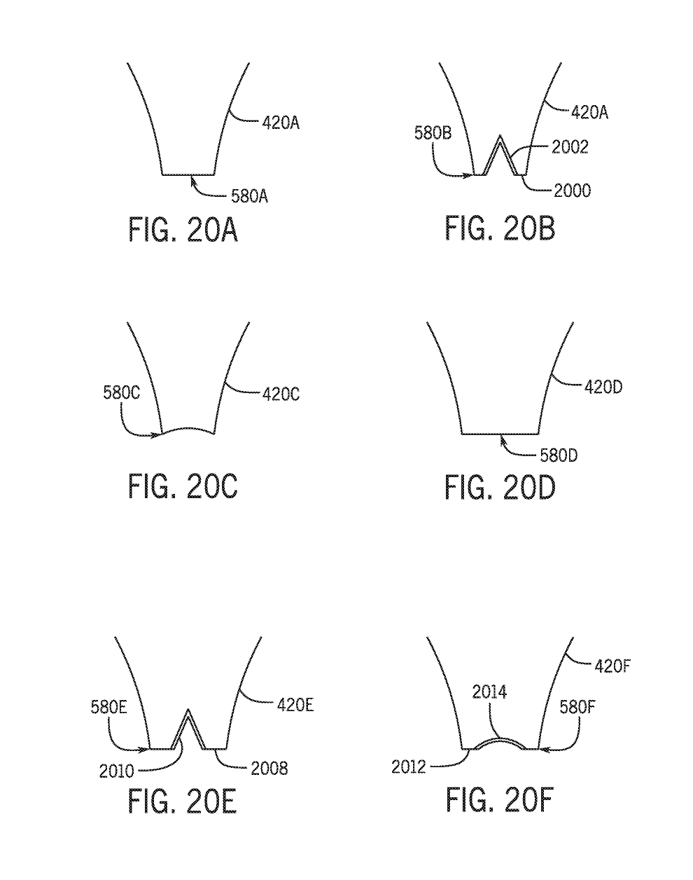

FIGS. 20A-20F are show various shapes of the end portion of each terminal projection of a tool for removing a push pin fastener, such as the embodiments shown in FIGS. 5, 11, 15, 16, and 19, for example, so as to accommodate the various shapes of the head portion and/or the shaft of a variety of push pin fasteners.

FIG. 20A shows a medium width terminal projection 420A with a flat end portion 580A.

FIG. 20B shows a medium width terminal projection 420B with an end portion 580B having a v-shaped notch 2002 between two narrow flat portions 2001.

FIG. 20C shows a medium width terminal projection 420C with a curved end portion 580C.

FIG. 20D shows a medium width terminal projection 420D with a flat end portion 580D.

FIG. 20E shows a medium width terminal projection 420E with an end portion 580E having a v-shaped notch 2010 between two narrow flat portions 2008.

FIG. 20F shows a medium width terminal projection 420F with an end portion 580F having a curved portion 2014 between two narrow flat portions 2012.

Embodiments of the invention are described herein in connection with an apparatus for removing push pin panel fasteners. It is to be understood, however, that the invention is not limited to the specific sizes, shapes, or applications described.

It is to be understood that this disclosure includes all possible combinations of such particular features, regardless of whether a combination is explicitly described. For example, where a feature is disclosed in the context of one particular aspect or embodiment of the invention, that feature can also be used, to the extent possible, in combination with and/or in the context of other particular aspects and embodiments of the invention.

Other modifications and implementations will occur to those skilled in the art without departing from the spirit and the scope of the invention as claimed. Accordingly, the above description is not intended to limit the invention, except as indicated in the following claims.

What is claimed is:

1. A tool configured to remove a fastener from a workpiece, the fastener including an outer insertable member configured for insertion into a hole in the workpiece and an inner member within the outer insertable member, wherein the outer insertable member expands in response to inward axial movement of the inner member to retain the fastener within the hole and contracts in response to an outward axial movement of the inner member from the outer insertable member to loosen the fastener from the hole, the tool comprising:
a first arm pivotally connected to a second arm, each of the first and second arms including:
a main arm extending from a pivot connection along a longitudinal axis, the main arm including an outer surface having a gripping portion configured for direct contact with a digit of a user,
a transverse portion extending from an end of the main arm along a first transverse axis that is substantially perpendicular to the longitudinal axis,
a terminal projection extending generally perpendicular and inwardly from the transverse portion, the terminal projection having a primary camming surface; and
a pivot arm extending along a second transverse axis that is generally perpendicular to the longitudinal axis; and
wherein the primary camming surfaces engage the inner member of the fastener upon application of an inward force at the gripping portions by digits of the user, and wherein the primary camming surfaces lift the inner member from the outer insertable member to enable extraction of the fastener from the workpiece when a rotational force is applied about the pivot arm with the pivot arm rested against a surface of the workpiece.

2. The tool of claim 1, wherein each of the first and second arms further comprise:
knurling along the outer surface at the gripping portions.

3. The tool of claim 1, wherein the terminal projection of each of the first and second arms has a first width proximate the respective transverse portion and tapers to a second width distal the respective transverse portion, wherein the first width is greater than the second width, and wherein the second width is less than a width of a radial groove in an upper portion of the outer insertable member.

4. The tool of claim 1, wherein the primary camming surface of each of the first and second arms is curved.

5. The tool of claim 4, wherein each of the first and second arms includes a further camming surface opposite the primary camming surface, and wherein the further camming surface is curved.

6. The tool of claim 4, wherein each of the first and second arms includes a further camming surface opposite the primary camming surface, and wherein the further camming surface is generally flat.

7. The tool of claim 1, wherein the primary camming surface of each of the first and second arms is shaped as a generally linear ramp.

8. The tool of claim 7, wherein each of the first and second arms includes a further camming surface opposite the primary camming surface, and wherein the further camming surface is generally flat.

9. The tool of claim 1, wherein each of the first and second arms includes an inner wall, wherein the transverse portion and pivot arm extend from the inner wall.

10. The tool of claim 1, further comprising:
a biasing member connected to the first arm and the second arm, the biasing member biasing the first arm and second arm away from each other.

11. A tool configured to remove a fastener from a workpiece, the fastener including an outer insertable member configured for insertion into a hole in the workpiece and an inner member within the outer insertable member, wherein the outer insertable member expands in response to inward axial movement of the inner member to retain the fastener within the hole and contracts in response to an outward axial movement of the inner member from the outer insertable member, the tool comprising:
a first arm pivotally connected to a second arm, each of the first and second arms including:
a main arm extending from a pivot connection along a longitudinal axis, the main arm including an outer surface having a gripping portion configured for direct contact with a digit of a user,
a transverse portion extending from an end of the main arm along a transverse axis that is substantially perpendicular to the longitudinal axis,
a terminal projection extending generally perpendicular to and inwardly from the transverse portion, the terminal projection having a primary camming surface; and
wherein the primary camming surfaces engage the inner member of the fastener upon application of an inward force at the gripping portions by digits of the user, and wherein the primary camming surfaces lift the inner member from the outer insertable member to enable extraction of the fastener from the workpiece when a lifting force is applied in a direction of the transverse axis.

12. The tool of claim 11, wherein each of the first and second arms further comprise:
knurling along the outer surface at the gripping portions.

13. The tool of claim 11, wherein the terminal projection of each of the first and second arms has a first width proximate the transverse portion and tapers to a second width distal the transverse portion, wherein the first width is greater than the second width, and wherein the second width is less than a width of a radial groove in an upper portion of the outer insertable member.

14. The tool of claim 11, further comprising a pivot arm extending along a further transverse axis that is generally perpendicular to the longitudinal axis, wherein application of a rotational force about the pivot arm with the pivot arm rested against a surface of the workpiece results in the lifting force along the transverse axis.

15. The tool of claim 11, wherein each of the first and second arms includes a further camming surface opposite the primary camming surface, and wherein the further camming surface is concave shaped.

16. The tool of claim 11, wherein each of the first and second arms includes a further camming surface opposite the primary camming surface, and wherein the further camming surface is generally flat.

17. The tool of claim 11, wherein the primary camming surface of each of the first and second arms is shaped as a generally linear ramp.

18. The tool of claim 17, wherein each of the first and second arms includes a further camming surface opposite the primary camming surface, and wherein the further camming surface is generally flat.

19. A tool configured to remove a fastener from a workpiece, the fastener including an outer insertable member configured for insertion into a hole in the workpiece and an inner member within the outer insertable member, wherein the outer insertable member expands in response to inward axial movement of the inner member to retain the fastener within the hole and contracts in response to an outward axial movement of the inner member from the outer insertable member, the tool comprising:
a first arm pivotally connected to a second arm, each of the first and second arms including:
a main arm extending from a pivot connection, the main arm including an outer surface having a gripping portion configured for direct contact with a digit of a user,
a tapered section extending from a lower portion of the main arm,
a terminal projection extending inward from the tapered section, the terminal projection having a primary camming surface; and
wherein the primary camming surfaces engage the inner member of the fastener upon application of an inward force at the gripping portions by digits of the user, and wherein the primary camming surfaces lift the inner member from the outer insertable member to enable extraction of the fastener from the workpiece when a lifting force is applied to cause outward axial movement of the inner member from the outer insertable member.

20. The tool of claim 18, wherein the outer insertable member includes a radial groove extending from an outer periphery thereof to an outer periphery of the inner member, and wherein the terminal projection of each of the first and second arms has a width that is less than a width of the radial groove.
